(19) United States
(12) Patent Application Publication
(10) Pub. No.: US 2023/0139339 A1
(43) Pub. Date: May 4, 2023

(54) METHOD AND SYSTEM FOR ADAPTIVE PRODUCT CATEGORIZATION

(71) Applicant: Shopify Inc., Ottawa (CA)

(72) Inventors: Kyle Bruce Tate, Ottawa (CA); Xinyi Zhao, Etobicoke (CA)

(21) Appl. No.: 17/881,961

(22) Filed: Aug. 5, 2022

Related U.S. Application Data
(60) Provisional application No. 63/275,715, filed on Nov. 4, 2021.

(51) Int. Cl. G06Q 30/02

(52) U.S. Cl. CPC G06Q 30/0204

(57) ABSTRACT

A method at a computing device for adaptive product categorization, the method including monitoring adoption of custom categories by merchants, the custom categories being custom additions to a standard taxonomy; clustering the custom categories to form clusters having associated cluster values; determining that a cluster value for a particular one of the custom categories exceeds a threshold; and adapting the standard taxonomy based on the particular one of the custom categories.

### FIELD OF THE DISCLOSURE

The present disclosure relates to electronic transactions, and in particular relates to product categorization related to electronic commerce transactions.

### BACKGROUND

Product categories are used in e-commerce platforms and sites to group similar products or services together to provide for an enhanced customer experience. In particular, categories may be used as a filter or facet on a search and allow potential purchasers to find a product quickly and also to present other similar products to the potential purchaser. Further, product categories may be used for defining the type of attributes needed from a potential purchaser for the type of products. Product categories may also be used in analytics to understand buyer preferences. Further, product categorization may define workflows for the products. For example, all products in a “boots” category require larger fulfilment boxes. Other uses for product categories are possible.

Product categorizations are often organized hierarchically, meaning that each lower-level category belongs to a broader higher-level category, and parent nodes can also belong to even higher-level categories, such that a tree-like structure is formed. The hierarchy can be as deep and as broad as desired.

Typically, a platform defines standard product categories across all merchants on the e-commerce platform. Such taxonomy is typically fixed.

However, in some cases a merchant may create custom product categories which extend a standard set of product categories. For example, a merchant of a specialized store may find the standard taxonomy limiting and want to use more granular categories. In other cases, the standard taxonomy may not capture a good or service in an emerging area.

### SUMMARY

One of the drawbacks of a standard fixed or static product categorization taxonomy is that it may become stale and thus less relevant over time. This is particularly the case in market environments having rapidly changing product mixes.

The present disclosure relates to extending a standard taxonomy for product categories by introducing an adaptive feature to the taxonomy that adds new desirable categories determined through an analysis of the custom categories used by merchants.

In one aspect, a method at a computing device for adaptive product categorization is provided. The method may include monitoring adoption of custom categories by merchants, the custom categories being custom additions to a standard taxonomy. The method may further include clustering the custom categories to form clusters having associated cluster values and determining that a cluster value for a particular one of the custom categories exceeds a threshold. The method may further include adapting the standard taxonomy based on the particular one of the custom categories.

In some embodiments, the clustering may comprise: associating values with the adoption of the custom categories by the merchants; and grouping the values based on the custom categories to form the clusters, the clusters having associated cluster values based on the grouped values for that cluster.

In some embodiments the clusters may correspond to respective ones of the custom categories.

In some embodiments, the clusters may correspond to groups of two or more of the custom categories.

In some embodiments the grouping may include, for a given custom category: finding a target cluster with a similarity index within a determined threshold of the given custom category; and generating the cluster value for the target cluster based on the values associated with the adoption of the given custom category by the merchants.

In some embodiments, values associated with the adoption of a given custom category by a given merchant may be based on a size of the given merchant.

In some embodiments, the values associated with the adoption of a given custom category by a given merchant may be based on whether a custom category node previously adopted by the given merchant was previously added to the standard node.

In some embodiments, the adapting may include automatically updating the standard taxonomy to include the particular one of the custom categories as a new standard node; and updating product classification for products using the particular one of the custom categories to the new standard node.

In some embodiments, the method may further include determining a parent node to the new standard node; identifying products categorized using the parent node; and providing an option to update the identified products to the new standard node.

In some embodiments, the adapting may include sending a request to the merchant to use an interim standard taxonomy having the particular one of the custom categories; receiving confirmation from the merchant; and converting the interim standard taxonomy to the standard taxonomy.

In some embodiments the method may further include, after the adapting, receiving instructions to delete the particular one of the custom categories and use the adapted standard taxonomy; and updating product classification for products using the particular one of the custom categories to a new standard node.

In some embodiments the monitoring may be based on a search of custom category nodes being used at an e-commerce platform.

In some embodiments the adapting may include creating a potential updated standard taxonomy; providing a poll to a plurality of recipients regarding the potential updated standard taxonomy; receiving a response from at least a subset of the plurality of recipients; and based on the response from at least a subset of the plurality of recipients, updating the standard taxonomy.

In one aspect, a computing device for adaptive product categorization may be provided. The computing device may include a processor; and a communications subsystem. The computing device may be configured to: monitor adoption of custom categories by merchants, the custom categories being custom additions to a standard taxonomy; cluster the custom categories to form clusters having associated cluster values; determine that a cluster value for a particular one of the custom categories exceeds a threshold; and adapt the standard taxonomy based on the particular one of the custom categories.

In some embodiments the computing device may be configured to cluster by: associating values with the adoption of the custom categories by the merchants; and grouping the values based on the custom categories to form the clusters, the clusters having associated cluster values based on the grouped values for that cluster.

In some embodiments, the clusters may correspond to respective ones of the custom categories.

In some embodiments, the clusters may correspond to groups of two or more of the custom categories.

In some embodiments, the computing device may be configured to group, for a given custom category, by finding a target cluster with a similarity index within a determined threshold of the given custom category; and generating the cluster value for the target cluster based on the values associated with the adoption of the given custom category by the merchants.

In some embodiments, values associated with the adoption of a given custom category by a given merchant may be based on a size of the given merchant.

In one aspect, a non-transitory computer readable medium for storing instruction code may be provided. When executed by a processor of a computing device configured for adaptive product categorization, the instruction code may cause the computing device to: monitor adoption of custom categories by merchants, the custom categories being custom additions to a standard taxonomy; cluster the custom categories to form clusters having associated cluster values; determine that a cluster value for a particular one of the custom categories exceeds a threshold; and adapt the standard taxonomy based on the particular one of the custom categories.

### BRIEF DESCRIPTION OF THE DRAWINGS

The present disclosure will be better understood with reference to the drawings, in which:

FIG. 1 is a block diagram showing an example e-commerce system capable of implementing the embodiments of the present disclosure.

FIG. 2 is a block diagram showing an example interface for a merchant using the e-commerce platform of FIG. 1.

FIG. 3 is a block diagram showing an example interface for a merchant to add a product using the e-commerce platform of FIG. 1.

FIG. 4 is a block diagram showing a simplified example of a standard taxonomy for an e-commerce platform.

FIG. 5 is a block diagram showing an example node capable of being used with the embodiments of the present disclosure.

FIG. 6 is a flow chart showing a process for adapting a custom node into a standard taxonomy.

FIG. 7 is a block diagram showing a simplified computing device capable of being used with the embodiments of the present disclosure.

### DETAILED DESCRIPTION

The present disclosure will now be described in detail by describing various illustrative, non-limiting embodiments thereof with reference to the accompanying drawings. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

In accordance with the embodiments of the present disclosure, methods and systems for extending a standard taxonomy for product categories is provided by introducing an adaptive feature to the taxonomy that adds new desirable categories determined through an analysis of the custom categories used by merchants.

The taxonomy is typically organized in a hierarchy and can be represented by a tree structure where all child node categories belong to their respective parent node. The desirability of a new standard category may be determined or inferred by predefined metrics such as the number of merchants using the new category or the proportion of such merchants. In addition, a combination of other additional factors such as a volume of purchased units within a predetermined time, dollar amount of sales within a period, sales growth, how frequently the new category was searched, and the like may also be considered.

The problem of allowing customizability while maintaining a standard taxonomy is solved by allowing merchants to store a standard product category in addition to a custom product category associated with each item in a merchants' inventory. For example, tables or records of product items can utilize two attributes to their product model: standard_type from the standard taxonomy and custom_type which stores the custom category chosen by the merchant. The custom categories are selected from a custom taxonomy which can be independent of the standard taxonomy. The custom taxonomy is also typically hierarchically organized. However, there will be a many-to-one mapping between categories of the custom taxonomy and categories of the standard taxonomy. Maintaining both the custom taxonomy and standard taxonomy provides backward compatibility for those merchants that adopt the standard taxonomy while maintaining their previous custom taxonomy.

A computing device associated with an ecommerce platform or merchant may be used to determine when a custom category node may be converted into the standard node taxonomy. This may be done by receiving information about custom category nodes being created by various merchants. For example, the information may be received by doing a crawl or scan of merchant products to determine the custom category nodes being used. In other cases, whenever a merchant populates a product or service with a custom category node, a notification may be sent to the computing device. Other options are possible.

When the computing device receives information that a custom category node is being utilized for a product or service, the computing device may attempt to group information from the custom category node with other custom category node information found within the system. For example, if two merchants are using the same string to identify a product category, the information from the two merchants may be clustered or grouped.

However, the clustering or grouping does not necessarily rely on string matches. Specifically, a category node may consist of a plurality of strings which are synonymous with each other in some cases. In other cases, categories may be grouped based on any form of lexical or string match. Further, regional information may be part of a node. For example, a hat may be referred to as a toque in Canada, a beanie in the United States or Australia, among other names. Therefore, the grouping may be based on synonyms or regional equivalents. In practice, a similarity index may be found between the custom category nodes and grouping may occur if the similarity index between the custom category nodes is within a defined threshold.

Further, a value may be added to the information being received from the merchants regarding custom category nodes. In the simplest example, each value may be identical.

However, in other cases the value may be weighted based on the source of the information or the type of information being provided. For example, a large merchant may be given more weight than a smaller merchant. This may be especially true if the large merchant has their own taxonomy department. In other cases, the weighting may be based on the value of sales of the merchant for the product category. Other options for weighting are possible.

When custom category node information is added to a cluster, the value may also be added to the cluster to create a cumulative value. Once the cumulative value reaches a determined threshold then the custom category node may be a candidate for becoming part of the standard node taxonomy.

The custom category may be added to the standard taxonomy in various ways. In some cases, one or more cluster of custom categories may be grouped and added as a single node within the standard node taxonomy. In some cases, the custom cluster may be renamed to a standard node within the standard node taxonomy. In some cases, a cluster of custom categories may be replaced with a standard node and standard node children, thus creating multiple new standard nodes.

In some cases, the standard node taxonomy may be adapted to include the custom category node automatically once the threshold value has been reached. In other cases, a request to a taxonomist may be made and only once the taxonomist has approved the adaptation of the standard node taxonomy is the standard node taxonomy changed. In other cases, crowd sourcing or other forms of approval for the changes may be used prior to the standard node taxonomy being changed.

Each aspect is described in more detail below.

### An Example E-Commerce Platform

Although integration with a commerce platform is not required, in some embodiments, the methods disclosed herein may be performed on or in association with a commerce platform such as an e-commerce platform. Therefore, an example of a commerce platform will be described.

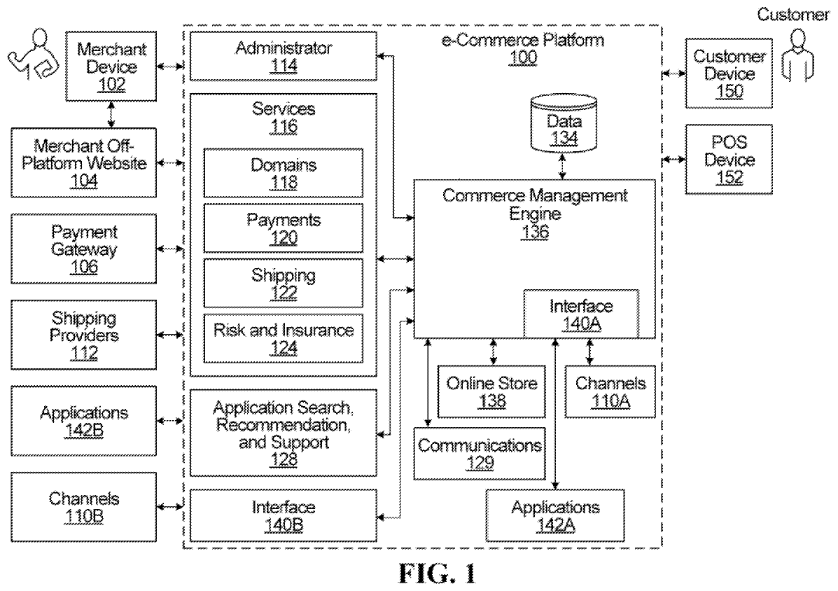

FIG. 1 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 1, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

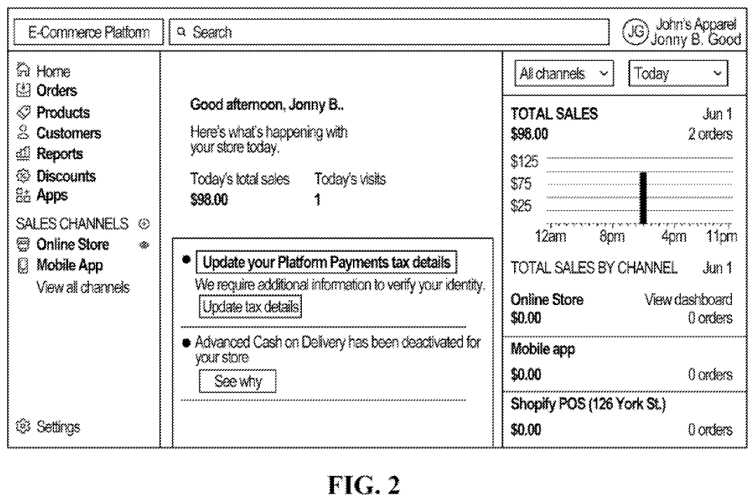

FIG. 2 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 2. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 1, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Standard and Custom Nodes

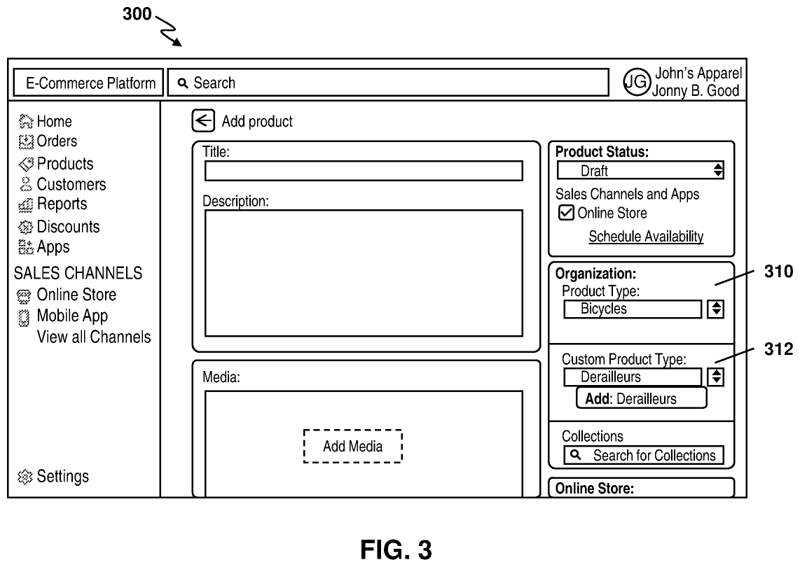

Utilizing an ecommerce platform such as the one described with regard to FIGS. 1 and 2 above, a merchant may add a new product. For example, the merchant may click on the “Products” link in the left column of FIG. 2, which, in some cases may then present the merchant with all of the products in their electronic storefront. Further an option may be presented to the merchant to add a new product. If the merchant selects the option to add a new product, a user interface such as the one provided in FIG. 3 may be presented to the merchant. Reference is now made to FIG. 3.

In the embodiment of FIG. 3, a user interface 300 is provided which allows a merchant to add a new product to their storefront. For example, the merchant may be allowed to add a title, description, media such as one or more photographs, videos, sound clips among other options, inventory amounts, barcodes or stock keeping units (SKUs), whether the product is part of a collection, whether the product should be placed in the storefront immediately, among other information.

In addition, the merchant may be requested to categorize the product. This may be done in several ways. In the example of FIG. 3, an organization section is provided in which a product type may be selected by the merchant. Such product type may utilize a standard taxonomy to provide the merchant with options for categorization. In the example of FIG. 3, box 310 allows only choices to be made for the standard taxonomy while box 312 allows for custom categories to be created. For example, the standard taxonomy may include bicycles as a standard node, but a specialized bicycle shop may want more detail and therefore want to add a “derailleurs” category. If such category does not exist then the merchant may type this into box 312 and an option to add derailleurs may be provided to the merchant.

However, the example of FIG. 3 is merely provided for illustration. In some cases, only box 310 may be provided and the merchant may be allowed to add custom categories within such box.

In some cases, the merchant may be requested to define a parent node for the custom category.

Other options are possible.

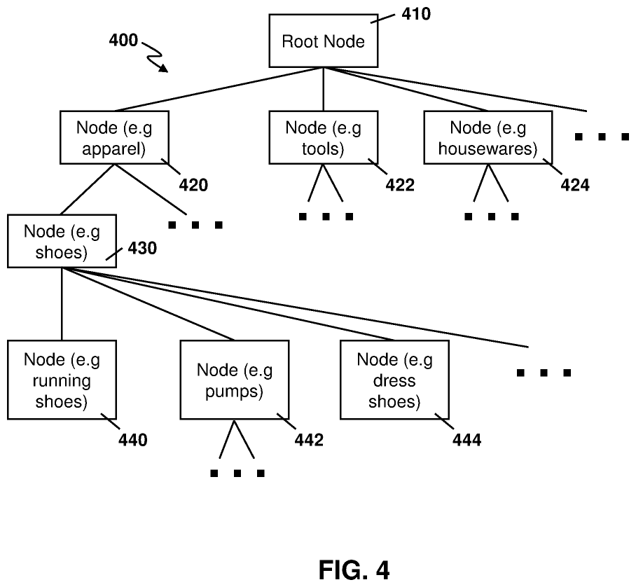

As described above, categorization is an important aspect of an electronic storefront, as categories may be used as a filter or facet on a search and allow potential purchasers to find a product quickly and also to present other similar products to the potential purchaser; categories may be used for defining the type of attributes needed from a potential purchaser for the type of products; categories may also be used in analytics to understand buyer preferences; and/or product categorization may define workflows for the products. Categories presented to a merchant when adding or modifying product information may be part of a standard taxonomy. Reference is now made to FIG. 4.

The example of FIG. 4 shows a standard taxonomy 400 in which a root node 410 provides the base of the tree. More granularity is introduced as the number of nodes between a given node and this root node 410 increases. For example, in the embodiment of FIG. 4, node 420 represents a general apparel category, node 422 represents a general tools category, node 424 represents a general housewares category, among other options.

Each of nodes 420, 422 and 424 may include child nodes. For simplicity, only node 430, shown as a child node of node 420, is provided in the example of FIG. 4. Node 430 represents a category for shoes.

Under node 430, various child nodes exist. These include a running shoes node 440, a pumps node 442, and a dress shoes node 444, among other options.

In some cases, the standard taxonomy may end at such child node. In other cases, the child node may have further children.

In many cases, the standard taxonomy will be enough to add a new product and categorize it correctly. However, a merchant or retailer may find that the standard taxonomy is limiting and wish to add other child nodes. For example, a merchant may wish to add more specialized running shoes such as basketball shoes, court shoes, or other similar specialized shoes under node 440 if such nodes do not already exist.

Therefore, an ecommerce platform may allow merchants to store a standard product category in addition to a custom product category associated with each item in a merchants' inventory. The custom taxonomy may also typically be hierarchically organized. However, there may be a many-to-one mapping between categories of the custom taxonomy and categories of the standard taxonomy.

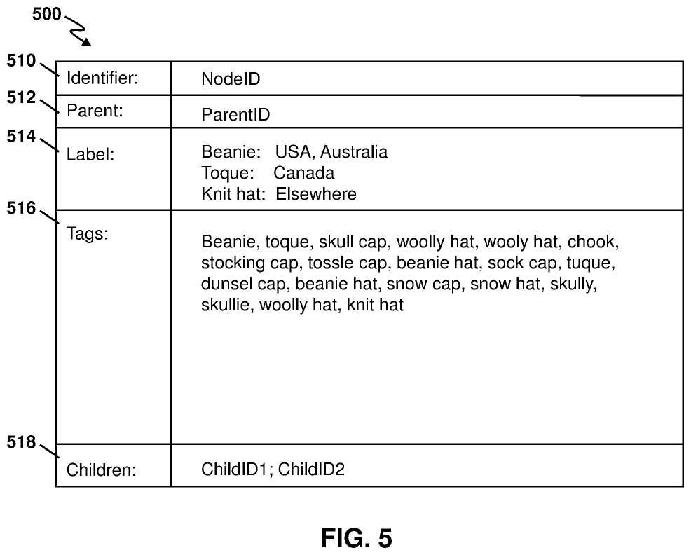

A standard node or custom node, as used here in, may be a data structure that provides information within a tree hierarchy. For example, reference is now made to FIG. 5.

The embodiment of FIG. 5 shows an example node 500 which includes an identifier 510. Identifier 510 maybe any unique identifier within the tree structure to identify the node. For example, the identifier may be a number, a label, a uniform resource identifier (URI), among other options.

The example of FIG. 5 further provides for a parent 512 to be identified utilizing the unique identifier for the parent, shown as parentID.

The example of a FIG. 5 further provides for a label 514 for the node. The label may be a single string for the tree, or may be conditional based on various criteria. For example, in FIG. 5, the label is identified based on a geographic location. Thus, the label for a woolen hat may be a “Beanie” for the USA and Australia; a “Toque” for Canada; and a “Knit hat” elsewhere. Other conditional information may include a language preference. For example, if a merchant is utilizing the product addition page utilizing Spanish as the default language, the label may be presented to the merchant in Spanish when adding a new product. While the example of FIG. 5 shows the label with only English strings, in some embodiments the label may be defined in multiple languages.

Therefore, label 514 may be a list of strings with one or more conditions attached thereto. A computing device presenting the label to a merchant or customer may scroll through the conditions to find the appropriate label. In some cases, a default or catch-all label may be provided if none of the conditions are met.

Further, in the example of FIG. 5, tags 516 are provided. Tags 516 may include the strings that are represented in the labels 514, but may also include synonyms, alternative spellings, translations into various languages, among other such information in some cases.

In some embodiments, tags 516 are optional and may be grouped with labels or may not be included at all.

Further, in the example of FIG. 5, children 518 are provided within a node 500. Children 518 may include zero, one or more children for the node.

However, in some cases, a node 500 may not define its children, as a link between a parent node and child node would be included in the child node using parent field 512. Similarly, in some cases parent field 512 is optional if the children field 518 is used. Therefore, the link between a parent node and a child node can be defined in both the parent node and the child node, in only the parent node, or only in the child node.

The embodiment and structure of a node 500 in FIG. 5 is merely provided as one example of a node, and the present disclosure is not limited to the particular structure of a node. Therefore, other node structures could equally be used with the embodiments of the present disclosure. Further, the node 500 could include other fields that are not included in the example of FIG. 5.

### Adapting a Standard Taxonomy Based on Custom Categories

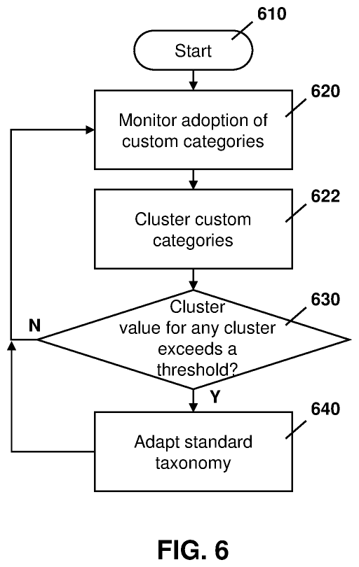

Reference is now made to FIG. 6. A computing device associated with an ecommerce platform or merchant, for example such as those described with regards to FIG. 1 above, may be used to determine when a custom category node may be converted into the standard node taxonomy.

In particular, the process of FIG. 6 starts at block 610 and proceeds to block 620 in which the computing device or system may monitor adoption of custom categories by merchants within the e-commerce platform. This may be done by receiving information about custom category nodes being created by various merchants.

In one embodiment, the information may be received by doing a crawl or scan of merchant products to determine the custom category nodes being used. For example, the computing device or system may look at each merchant within the ecommerce platform and all of the products or services that the merchant is selling. The computing device or system may then compile the products or services that are categorized utilizing custom categories.

Further, in some embodiments, whenever a merchant populates a product or service with a custom category node, a notification may be sent to the computing device or system. For example, the product addition or product editing page on the merchant's e-commerce portal may include code that when a custom category is used, a notification about the use of the custom category is provided to a specific address or application program interface (API) for the computing device or server compiling the results. Other options are possible.

In some embodiments the computing device may only do one of the crawl or scan and the receipt of notifications. In other embodiments the computing device may do both.

Whenever a custom category is found to be used, the process proceeds from block 620 to block 622 in which the computing device or system may cluster custom categories. Specifically, the computing device may attempt to group information from the custom category node with other custom category node information found within the system. For example, if two merchants are using the same string to identify a product category, the information from the two merchants may be clustered or grouped.

In some embodiments, the clustering or grouping does not necessarily rely on string matches. Specifically, a category node may consist of a plurality of strings which are synonymous with each other. For example, pumps, stilettos and high heals may be part of one cluster. In other cases, sneakers, running shoes and training shoes may be part of the same cluster.

In some embodiments, a similarity index may be found between the custom category nodes and grouping may occur if the similarity index between the custom category nodes is within a defined threshold. The similarity index may, for example, be based on any algorithm that compares the custom node with other custom nodes or clusters. For example, dictionary lookups may be used to find alternative spellings or thesaurus lookups may be used to find synonyms. In some cases, artificial intelligence (AI) algorithms could compare the custom nodes and/or clusters. For example, the AI algorithm could use machine learning to scan storefronts or the internet to determine different names for the same item and use this information to group the custom nodes.

In some cases, where a cluster already has two or more custom nodes associated therewith, the similarity index between the new node and any one of the nodes within the cluster may need to be greater than a threshold. In some cases, the average similarity index between each node associated with the cluster and the new node needs to be greater than a threshold. Other options are possible.

In some embodiments, when the similarity index is below the threshold for all currently existing clusters then a new cluster may be created with only the custom node in it.

In general, any form of lexical or string match may be used to group two custom categories into a cluster.

Further, when grouping an adopted custom node into a cluster, a value may be added to the information being received from the merchants regarding custom category nodes. In the simplest example, each value may be identical. For example, each custom node that is added to a cluster may have a value of “1”.

However, in other cases the value may be weighted based on the source of the information or the type of information being provided. For example, a large merchant may be given more weight than a smaller merchant. In other cases, the weighting may be based on the value of sales of the merchant for the product category. Other options for weighting are possible. This may be especially true if the large merchant has their own taxonomy department. Thus, instead of the example value of “1”, a custom node from a large merchant may have its value multiplied by a weighting factor.

For example, if the average merchant sales volume on the e-commerce platform is compared with the sales volume for the merchant with the custom category, this may shift the value given to the custom node down for a smaller merchant, and up for a larger merchant, by sales volume on the platform.

If a merchant has their own taxonomy department, then a value may be added to the weighting factor, for example.

In some embodiments, if a merchant has previously had a custom category adopted into the standard taxonomy, a value or weight may be added to another custom node adopted by the merchant.

Other options for weighting the value of the custom node are possible.

When custom category node information is added to a cluster, the value may also be added to the cluster to create a cumulative value. For example, if an identical weight is given to each custom node added to a cluster, then the value of the cluster is merely a count of the custom nodes times the value for each node. If weighting factors are used, then the cumulative value of the cluster will depend on the weighted values for each custom node within the cluster.

Once a custom node is added to a cluster, the process proceeds from block 622 to block 630 in which a check is made to determine whether the cumulative value of the cluster now exceeds a threshold. If not, the process proceeds from block 630 back to block 620 to continue to monitor the adoption of custom categories.

Conversely, once the cumulative value for a cluster reaches a determined threshold then the cluster may be a candidate for becoming part of the standard node taxonomy.

The candidate cluster may then be adapted into the standard taxonomy in various ways. Further, the candidate cluster may be formatted in various ways when being added to the standard taxonomy.

In some embodiments, the candidate cluster may be formatted to an appropriate format for a node in the standard taxonomy. For example, if the node of FIG. 5 is used as a node in the standard taxonomy, then the cluster may be formatted to include a unique identifier for the node. Further, in some cases, the custom cluster will include information about parent nodes in the standard taxonomy. However, in other cases, a parent node may need to be derived, for example, using algorithms, through inquiry, utilizing artificial intelligence, among other options.

In some embodiments, a label for the node may need to be created. The label can use the labels that were most prevalent in the custom nodes found within the cluster being converted. In other cases, the label may utilize a value from the most heavily weighted merchant. In other cases, the label may be created to include conditional factors such as geographic location, language preferences, among other options. In some cases, machine learning algorithms may be utilized to create the label based on other labels found within the e-commerce platform, other e-commerce platforms, on the Internet, among other options. Thus, the label may be created utilizing rules at the computing device for label creation.

Further, if tags are being utilized, the tags may be created from the custom nodes within the cluster. For example, different spellings, variations, or synonyms that are being used by various merchants may be included within tags for the new node. In other cases, dictionaries, thesauruses, artificial intelligence algorithms or other classification algorithms could be utilized to create tags. Other options are possible.

In some embodiments, only a single node is added to the standard taxonomy. However, in other cases, multiple nodes may be added to the standard taxonomy. For example, the cluster may be determined to represent a parent node and several children nodes, and this structure may be proposed to be added to the standard taxonomy. In other cases, the computing device may determine that it would be preferrable to add two nodes rather than a single node. For example, such preference may be based on the similarity score between nodes within the cluster.

Therefore, one or more proposed nodes may be considered to be added to the standard taxonomy. Referring again to FIG. 6, the process then proceeds from block 630 to block 640

At block 640, in some cases, the standard node taxonomy may be automatically adapted to include the custom category node once the threshold value has been reached and the standard node created. Therefore, the only factor in this case would be the threshold being reached, after which the node or nodes would be added to the standard taxonomy.

In some cases, at block 640, a request may be sent to a recipient from the computing device and a response may need to be received in order to add the node or nodes to the standard taxonomy. For example, in one case the request may be sent to a taxonomist and the response received once the taxonomist has approved the adaptation of the standard node. In other cases, the request may be sent to a System Administrator, or any designated recipient for the ecommerce platform, among other options. The request and response can take various forms including the use of an administrative portal for the e-commerce platform, email or text messaging between the platform and the recipient, a designated application program interface, among other options.

In still further cases, the proposed change to the taxonomy may be crowd sourced for approval. For example, once the cumulative value of a potential node has reached a threshold value then the merchants within an ecommerce platform may be polled to determine whether the standard node taxonomy should be changed. This may be done by sending a message to the merchants, by creating a pop up or poll area within the merchants' administrative portal, among other options. Voting could be based on a simple majority in some cases. In other cases, a threshold percentage of merchants would need to agree. In some cases, a merchant's vote may be weighted similar to the weighting used for providing a value to a custom node within a cluster described above.

Further, in addition to crowd sourcing whether the node should be added to the standard taxonomy, in some cases the content of the node such as the label, tags, parent or other similar information could also be provided to the merchants for their comment or voting.

Based on the results received from the merchant, the node or nodes may be modified if the content of the node is in question and the node or nodes may be added to the standard taxonomy if the threshold value of votes is received.

In still a further embodiment, at block 640, once the threshold cumulative value has been reached, an interim change to the standard node taxonomy may be made and this change may be presented to the merchants who used the custom category node to determine whether such merchants would be willing to adapt to the interim change. If enough merchants adapt to the interim change, then the change may become part of the standard node taxonomy. For example, a threshold percentage of merchants who use a node within the cluster are willing to change from utilizing such custom node to utilizing a standard node in the standard taxonomy, this may be an indication of acceptance of the change to the standard taxonomy, at which point this standard taxonomy may be rolled out to the remaining merchants within the e-commerce platform.

From block 640, the process proceeds back to block 620 to continue to monitor the use of custom nodes within the ecommerce platform and there why continually refreshing the standard taxonomy.

### Adoption of the Revised Standard Taxonomy

Once the standard node taxonomy has been changed, then those merchants that are using a custom node now part of the standard taxonomy may be requested to update the product profile.

in one environment, a merchant may be requested to delete the custom category node and use the new standard node taxonomy.

In other embodiments, this change may be automated and the custom category node may be deleted automatically on behalf of the merchant and replaced with the new standard node taxonomy.

in other embodiments, the merchant may be requested to nest a custom node under a standard taxonomy node. For example, if a new node is added to the standard taxonomy then a scan of custom notes may find that some custom nodes may be nested under such new node and a request may be provided to merchants for that purpose.

Other options for dealing with custom nodes once the standard taxonomy has changed are also possible.

### Computing Device

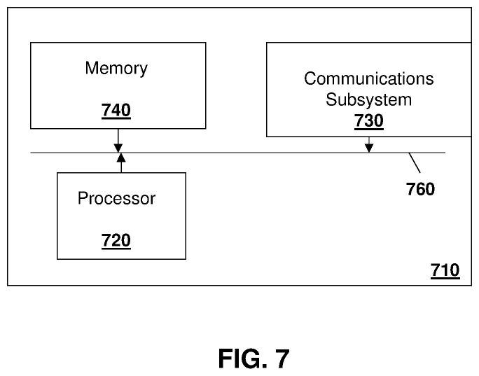

The above-discussed methods are computer-implemented methods and require a computer for their implementation/use. Such computer system could be implemented on any type of, or combination of, network elements or computing devices. For example, one simplified computing device that may perform all or parts the embodiments described herein is provided with regard to FIG. 7.

In FIG. 7, computing device 710 includes a processor 720 and a communications subsystem 730, where the processor 720 and communications subsystem 730 cooperate to perform the methods of the embodiments described herein.

The processor 720 is configured to execute programmable logic, which may be stored, along with data, on the computing device 710, and is shown in the example of FIG. 7 as memory 740. The memory 740 can be any tangible, non-transitory computer readable storage medium, such as DRAM, Flash, optical (e.g., CD, DVD, etc.), magnetic (e.g., tape), flash drive, hard drive, or other memory known in the art. In one embodiment, processor 720 may also be implemented entirely in hardware and not require any stored program to execute logic functions. Memory 740 can store instruction code, which, when executed by processor 720 cause the computing device 710 to perform the embodiments of the present disclosure.

Alternatively, or in addition to the memory 740, the computing device 710 may access data or programmable logic from an external storage medium, for example through the communications subsystem 730.

The communications subsystem 730 allows the computing device 710 to communicate with other devices or network elements. In some embodiments, communications subsystem 730 includes receivers or transceivers, including, but not limited to, ethernet, fiber, Universal Serial Bus (USB), cellular radio transceiver, a Wi-Fi transceiver, a Bluetooth transceiver, a Bluetooth low energy transceiver, a GPS receiver, a satellite transceiver, an IrDA transceiver, among others. As will be appreciated by those in the art, the design of the communications subsystem 730 will depend on the type of communications that the transaction device is expected to participate in.

Communications between the various elements of the computing device 710 may be through an internal bus 760 in one embodiment. However, other forms of communication are possible.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A method at a computing device for adaptive product categorization, the method comprising:
monitoring adoption of custom categories by merchants, the custom categories being custom additions to a standard taxonomy;
clustering the custom categories to form clusters having associated cluster values;
determining that a cluster value for a particular one of the custom categories exceeds a threshold; and
adapting the standard taxonomy based on the particular one of the custom categories.

2. The method of claim 1, wherein the clustering comprises:
associating values with the adoption of the custom categories by the merchants; and
grouping the values based on the custom categories to form the clusters, the clusters having associated cluster values based on the grouped values for that cluster.

3. The method of claim 1, wherein the clusters correspond to respective ones of the custom categories.

4. The method of claim 1, wherein the clusters correspond to groups of two or more of the custom categories.

5. The method of claim 4, wherein the grouping includes, for a given custom category:
finding a target cluster with a similarity index within a determined threshold of the given custom category; and
generating the cluster value for the target cluster based on the values associated with the adoption of the given custom category by the merchants.

6. The method of claim 1, wherein values associated with the adoption of a given custom category by a given merchant are based on a size of the given merchant.

7. The method of claim 1, wherein the values associated with the adoption of a given custom category by a given merchant are based on whether a custom category node previously adopted by the given merchant was previously added to the standard node.

8. The method of claim 1, wherein the adapting comprises:
automatically updating the standard taxonomy to include the particular one of the custom categories as a new standard node; and
updating product classification for products using the particular one of the custom categories to the new standard node.

9. The method of claim 8, further comprising:
determining a parent node to the new standard node;
identifying products categorized using the parent node; and
providing an option to update the identified products to the new standard node.

10. The method of claim 1, wherein the adapting comprises:
sending a request to the merchant to use an interim standard taxonomy having the particular one of the custom categories;
receiving confirmation from the merchant; and
converting the interim standard taxonomy to the standard taxonomy.

11. The method of claim 1, further comprising, after the adapting, receiving instructions to delete the particular one of the custom categories and use the adapted standard taxonomy; and
updating product classification for products using the particular one of the custom categories to a new standard node.

12. The method of claim 1, wherein the monitoring is based on a search of custom category nodes being used at an e-commerce platform.

13. The method of claim 1, wherein the adapting comprises:
creating a potential updated standard taxonomy;
providing a poll to a plurality of recipients regarding the potential updated standard taxonomy;
receiving a response from at least a subset of the plurality of recipients; and
based on the response from at least a subset of the plurality of recipients, updating the standard taxonomy.

14. A computing device for adaptive product categorization, the computing device comprising:
a processor; and
a communications subsystem,
wherein the computing device is configured to:
monitor adoption of custom categories by merchants, the custom categories being custom additions to a standard taxonomy;
cluster the custom categories to form clusters having associated cluster values;
determine that a cluster value for a particular one of the custom categories exceeds a threshold; and
adapt the standard taxonomy based on the particular one of the custom categories.

15. The computing device of claim 14, wherein the computing device is configured to cluster by:
associating values with the adoption of the custom categories by the merchants; and
grouping the values based on the custom categories to form the clusters, the clusters having associated cluster values based on the grouped values for that cluster.

16. The computing device of claim 14, wherein the clusters correspond to respective ones of the custom categories.

17. The computing device of claim 14, wherein the clusters correspond to groups of two or more of the custom categories.

18. The computing device of claim 17, wherein the computing device is configured to group, for a given custom category, by:
finding a target cluster with a similarity index within a determined threshold of the given custom category; and
generating the cluster value for the target cluster based on the values associated with the adoption of the given custom category by the merchants.

19. The computing device of claim 14, wherein values associated with the adoption of a given custom category by a given merchant are based on a size of the given merchant.

20. A non-transitory computer readable medium for storing instruction code, which, when executed by a processor of a computing device configured for adaptive product categorization cause the computing device to:
monitor adoption of custom categories by merchants, the custom categories being custom additions to a standard taxonomy;
cluster the custom categories to form clusters having associated cluster values;
determine that a cluster value for a particular one of the custom categories exceeds a threshold; and
adapt the standard taxonomy based on the particular one of the custom categories.
